(19) United States
(12) Patent Application Publication
(10) Pub. No.: US 2025/0321134 A1
(43) Pub. Date: Oct. 16, 2025

(54) Thermoelectric self-charging scale

(71) Applicants: University of Oregon, Eugene, OR (US); Portland State University, Portland, OR (US)

(72) Inventors: Christopher H. Hendon, Eugene, OR (US); Joshua Mendez, Portland, OR (US)

(21) Appl. No.: 19/175,358

(22) Filed: Apr. 10, 2025

Related U.S. Application Data
(60) Provisional application No. 63/632,088, filed on Apr. 10, 2024.

(51) Int. Cl. G01G 23/00

(52) U.S. Cl. CPC G01G 23/007

(57) ABSTRACT

A thermoelectric powered digital scale has a weighing platform with an array of thermoelectric generator cells adapted to produce electrical energy when a hot or cold object is weighed. A switching network adaptively changes the electrical circuit topology of the thermoelectric generator cells between parallel, series, or a combination. A power management circuit is adapted to harvest electrical energy from the array of thermoelectric generator cells and adaptively provide power for operating the scale and for recharging the rechargeable battery. A thermal cooling element with a collection of fins is adapted to dissipate heat from the bottom side of the cells.

### CROSS-REFERENCE TO RELATED APPLICATIONS

This application claims priority from U.S. Provisional Patent Application 63/632,088 filed Apr. 10, 2024, which is incorporated herein by reference.

### STATEMENT OF FEDERALLY SPONSORED RESEARCH

None.

### FIELD OF THE INVENTION

The present invention relates generally to digital counter-top scales. More specifically, it relates to rechargeable battery-powered digital scales.

### BACKGROUND OF THE INVENTION

In kitchens and laboratories, one of the most common instruments is a weight scale. A common type of consumer scale is a portable battery-powered scale, which uses a microcontroller to convert a signal from a load cell to a weight and display the weight value on an liquid crystal display (LCD). The battery lifetime of a conventional scale is typically 30-40 h. When these battery-powered scales are continuously used throughout the day every day, the battery will require unexpected and frequent recharging or replacement, which inconveniently interrupts a kitchen or laboratory workflow. When brewing coffee, for example, a scale is crucial for ensuring a consistent coffee-to-water ratio, and timing is also crucial during brewing. So, an interruption to change the scale's battery during the middle of coffee brewing can interfere with the desired outcome.

### SUMMARY OF THE INVENTION

The present invention provides a self-charging scale that does not require changing its battery or plugging it into an external power source for recharging. The scale uses thermal energy harvesting to power the device and recharge the battery. Specifically, an array of thermoelectric generator (TEG) cells just beneath the top surface of the scale generate electrical power from a hot or cold item placed on the scale. For example, when brewing coffee, the hot coffee on the scale generates a temperature differential between the top and bottom sides of the TEG array. This harvested energy is used to power the scale during use, and any excess energy is used to recharge the battery. As a result, the device will always have power during coffee brewing and other tasks where the object being weighed is hotter (or colder) than ambient temperature.

Because the power from the TEG array depends on the magnitude of the temperature differential, the scale includes a switching network and power management unit to dynamically reconfigure the TEG array circuit topology and adaptively convert, regulate, and route the electrical power to different components of the device.

In addition to weight, the scale may display the temperature differential between the warm and cold sides of the components, the change in weight with respect to time, and time elapsed since the scale first detected a temperature differential. The scale can also automatically turn on and/or tare in response to a detected temperature differential.

By attaching the scale to an external power source, the external electrical power can operate the thermoelectric array in reverse, so that the scale functions as a hot plate or cold plate.

In one aspect, the invention provides a thermoelectric powered digital scale comprising: a weighing platform comprising an array of thermoelectric generator cells and a surface plate attached to a top side of the array, wherein the array is adapted to produce electrical energy from a temperature gradient across opposite sides of the array; a switching network electrically connected to the array; a load cell mechanically coupled to the weighing platform; a thermal cooling element thermally coupled to a bottom side of the array and comprising a thermal block and a collection of fins adapted to dissipate heat; a digital display; a rechargeable battery; and a microcontroller circuit electrically connected to the switching network and the digital display. The microcontroller is adapted to determine a weight from signals received from the load cell and send signals indicating the weight to the digital display. The microcontroller is adapted to control the switching network to adaptively change between multiple electrical circuit topologies of the thermoelectric generator cells. The thermoelectric powered digital scale also comprises a power management circuit electrically connected to the switching network, the rechargeable battery, and the microcontroller, wherein the power management circuit comprises an energy harvesting circuit and a voltage regulation circuit. The energy harvesting circuit is adapted to harvest electrical energy from the array of thermoelectric generator cells. The power management circuit is adapted to provide operating power to the microcontroller and the display. The power management circuit is adapted use available power from the energy harvesting circuit for the operating power and for recharging the rechargeable battery.

In some embodiments, the power management circuit is adapted use power from the rechargeable battery for the operating power when the electrical energy generated by the thermoelectric cell array is insufficient to provide operating power to the microcontroller and the display.

In some embodiments, the thermoelectric powered digital scale further comprises a thermal switch adapted to divert energy to the rechargeable battery when the electrical energy from the array drops below a predetermined threshold power.

In some embodiments, the power management circuit is adapted to maximize power delivered to the rechargeable battery depending on power consumption and a charge state of the rechargeable battery.

In some embodiments, the power management circuit is adapted to perform maximum power point tracking (MPPT).

In some embodiments, the thermoelectric powered digital scale further comprises an external power port electrically connected to the power management circuit, wherein the power management circuit is adapted to receive external electrical power to charge the rechargeable battery and/or to operate the thermoelectric cells in reverse to function as a hot plate or a cold plate.

In some embodiments, the microcontroller is adapted to control the switching network to adaptively select individual cells in the array based on which cells are generating power.

In some embodiments, the microcontroller is adapted to control the switching network to adaptively select between a series topology, a parallel topology, and a mixture of series and parallel circuit topologies of the thermoelectric generator cells.

In some embodiments, the thermoelectric powered digital scale further comprises temperature sensors thermally coupled to the top side of the array and to the bottom side of the array, wherein the microcontroller circuit is electrically connected to the temperature sensors and is adapted to determine a temperature differential.

In some embodiments, the array of thermoelectric generator cells comprises vertically stacked thermoelectric generator cells having various different sizes.

In some embodiments, the thermoelectric generator cells comprise a material with a thermoelectric figure of merit, zT, that exceeds 0.2.

In some embodiments, the thermoelectric generator cells have a thickness of at least 2 mm.

In some embodiments, the surface plate comprises a material with a thermal conductivity exceeding 100 W/m·K.

In some embodiments, the surface plate comprises a material film with a thickness less than 1 mm.

In some embodiments, the microcontroller is adapted to compute a dynamic estimate of a change in weight per unit time.

In some embodiments, the microcontroller is adapted to automatically tar the scale when the electrical energy from the array changes from zero to a positive value.

### BRIEF DESCRIPTION OF THE DRAWINGS

FIG. 1A is an exploded view of key components of a thermoelectric powered digital scale according to an embodiment of the invention.

FIG. 1B are perspective views of a thermoelectric powered digital scale, illustrating several examples of cell sizes and circuit topologies, according to embodiments of the invention.

FIG. 2 is a perspective view of three stacked thermoelectric cells, according to an embodiment of the invention.

FIG. 3A shows a schematic block diagram of a thermoelectric scale according to an embodiment of the invention.

FIG. 3B is a schematic circuit diagram showing an example implementation of a TEG-based charging circuit according to an embodiment of the invention.

FIG. 4A is a schematic circuit diagram showing an example implementation of four TEG cells in a parallel/series switchable array, according to an embodiment of the invention.

FIG. 4B is a schematic circuit diagram showing components used for switching between heating and cooling modes using a polarity reversal circuit, according to an embodiment of the invention.

FIG. 5A is a perspective top view of a thermoelectric scale according to an embodiment of the invention.

FIG. 5B is a perspective bottom view of a thermoelectric scale according to an embodiment of the invention.

### DETAILED DESCRIPTION OF THE INVENTION

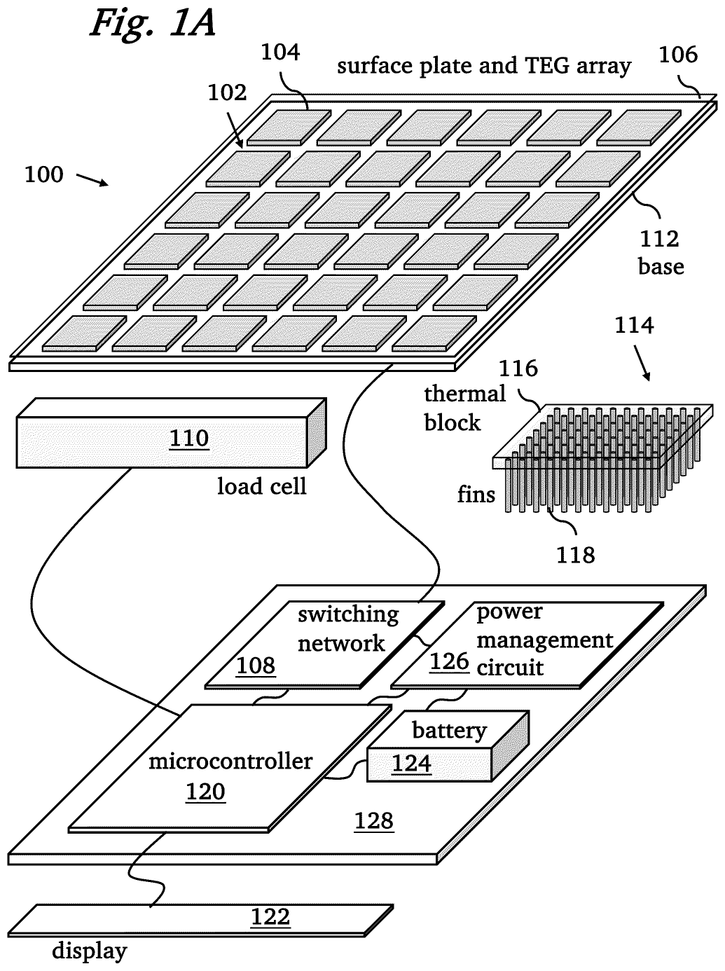

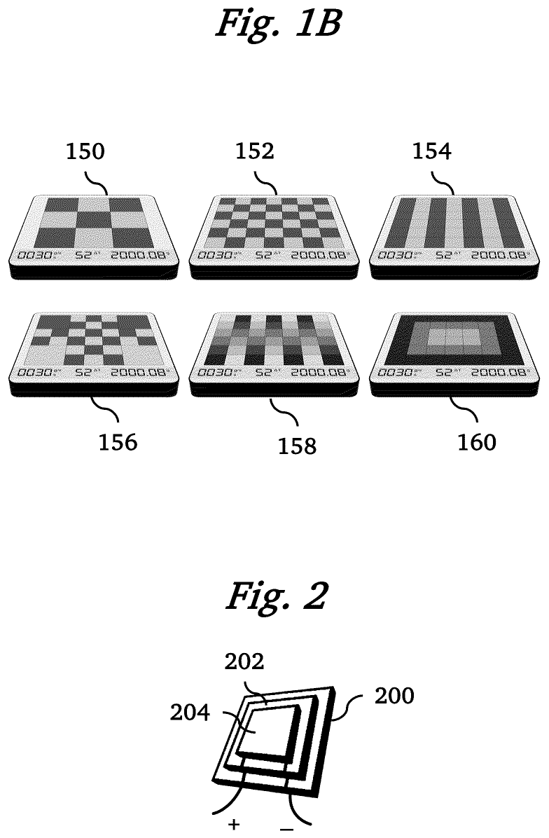

FIG. 1A shows an exploded view of key components of a thermoelectric powered digital scale according to an embodiment of the invention. A weighing platform 100 has an array 102 of thermoelectric generator (TEG) cells 104 and a surface plate 106 attached to a top side of the array 102. The TEG cells in the array produce electrical energy in response to a temperature gradient across opposite sides of the TEG cells. The array 102 is electrically connected to a switching network 108. A load cell 110 (e.g., a capacitive load cell) is mechanically coupled to a supporting base plate 112 of weighing platform 100. A thermal cooling element 114 is thermally coupled to the base 112 of weighing platform 100 and has a thermal block 116 and a collection of fins 118 that dissipate heat to air or liquid. A microcontroller 120 is electrically connected to the load cell 110 and converts signals received from the load cell into a weight value. The microcontroller 120 is also connected to a digital display 122 that displays the weight value to a user. The microcontroller 120 and display 122 are connected to and powered by a rechargeable battery 124. The microcontroller 120 is electrically connected to the switching network 108 and controls the switching network to adaptively change between multiple electrical circuit topologies of the thermoelectric generator cells. For example, the switching network can adaptively select between a series topology, a parallel topology, and a mixture of series and parallel circuit topologies of the thermoelectric generator cells. The cells are wired in either parallel or series, or a combination thereof, to achieve high current or high voltage, respectively. The switching network also can adaptively select individual cells in the array for operation based on which cells are generating power.

A power management circuit 126 is electrically connected to the switching network 108 and includes an energy harvesting circuit and a voltage regulation circuit. The energy harvesting circuit in the power management circuit 126 harvests electrical energy received from the array 102 via the switching network 108. The power management circuit 126 uses the harvested energy to provide operating power to the microcontroller 120 and, in turn, to the display 122. The power management circuit 126 also uses any extra available power from the energy harvesting circuit for recharging the rechargeable battery 124. When the electrical energy generated by the thermoelectric cell array 102 does not provide sufficient operating power, energy from the rechargeable battery 124 is used for operating power.

In some embodiments, the power management circuit 126 may include capacitors for storing excess low voltage and/or low current charge generated by the thermoelectric cells

In some embodiments, the scale may include an external power port to provide external electrical power to charge the rechargeable battery 124 and/or to operate the thermoelectric array 102 in reverse to function as a hot plate or a cold plate.

In one implementation, the TEG cells 104 are made of a thin-film thermoelectric material, such as Bi₂Te₃, which may be embedded in the surface 106 or base 112. The TEG cells 104 may also be separate devices sandwiched between the surface 106 and the base 112.

In some embodiments, the scale is adapted to fit in conventional settings that other scales are presently used in coffee brewing. This includes geometries that fit on the shelf of an espresso machine and underneath the espresso portafilter. The weighing platform in these applications is large enough to accommodate conventional glassware in other receptacles that are conventionally used to collect warm liquids. For example, in these embodiments, the height limit of the scale is approximately 35 mm, and the length and width limits both are approximately 170 mm. However, there are examples in coffee brewing where the geometry can become larger than this and in those embodiments the device is expected to perform better due to more opportunities for heat management. Also, the thermoelectric scale may be used in a laboratory setting to weigh objects such as urine, blood, and other liquids with elevated temperature relative to room temperature. The thermoelectric scale can also weigh objects that are cooler than ambient temperature. Examples include weighing snow and water.

The scale preferably has a weight capacity suitable to the application. In coffee applications the preferred embodiment would permit a maximum weight capacity of 3 kg with a resolution of 0.01 g. Other applications naturally may have lower or higher weight capacity and resolution. For example, if the scale is being used to make measurements of snow, there may be examples where the scale should read at a resolution of 1 g with a load capacity of 10 kg.

The scale has a digital display 122 built into the top or side. In addition to displaying the weight, the display may also report elapsed time or a countdown time. It may also display a dynamic estimate of change in mass over time (e.g. flow rate in liquid examples, in the units of grams per second counting up to ˜30 g/s with a resolution of 1 g/s), and it may include a report of temperatures of the opposite sides of the thermoelectric cells (ΔT in ° C., with the resolution of one to five degrees). The device preferably has a power button to turn on and off the device, and a button to tare the scale.

The TEG cells 104 may be comprised of any thermoelectric material including but not limited to Bismuth telluride (Bi₂Te₃), Lead telluride (PbTe), Bismuth antimony telluride (Bi—Sb—Te), Silicon germanium (SiGe), All half-Heusler alloys, Skutterudites (e.g., CoSb₃), Zinc antimonide (ZnSb), Bismuth selenium (Bi₂Se₃), Lead selenide (PbSe), Calcium cobalt oxide (Ca₃Co₄O₉), Magnesium silicide (Mg₂Si), Tin selenide (SnSe), Strontium titanium oxide (SrTiO₃), Nickel oxide (NiO), Iron disilicide (FeSi₂), Copper selenide (Cu₂Se), Iron antimonide (FeSb₂), Cobalt oxide (CoO). More generally, the TEG cells may be composed of any thermoelectric material with a thermoelectric figure of merit, zT, that exceeds 0.2. This limit is important because lower figure of merits result in poor conversion to voltage and current. The thickness of the cells will be dictated by the form factor of the scale, but the cells preferably are no less than 2 mm thick, so that the temperature equilibration occurs slowly. In a preferred embodiment, the thermoelectric cells are arranged in a grid or other pattern forming a region whose area is 75% or more of the surface area of the weighing platform.

The top surface plate 106 of the scale is preferably not a thermal insulator, and is preferably a good thermal conductor, i.e., a thermal conductor that exceeds 100 W/m·K. In ideal embodiments, the surface will be made from a layer of any of the following materials: Diamond (2200 W/m·K), Graphene (2000 to 5000 W/m·K), Graphite (1500 W/m·K), Silver (429 W/m·K), Copper (401 W/m·K), Aluminum (237 W/m·K), Gold (317 W/m·K), Silicon carbide (SiC, 120-200 W/m·K), Boron nitride (BN, typically around 200-400 W/m·K), Tungsten (173 W/m·K), Zinc (116 W/m·K)/More generally, any carbide, nitride, or metal including (stainless) steels (45 W/m·K) may suffice. In the preferred embodiment, aluminum would be favored for processability and cost, and also because it can be precision machined to be thin.

In some embodiments, the top surface plate 106 need not be a good thermal conductor, provided the material can be manufactured sufficiently thin. Since the thermal conductivity depends on thickness, thin insulators (<100 W/m·K) can perform better than thick conductors. Thus, in other embodiments, any surface material can be used for the top surface plate 106 so long as it is manufactured to be sufficiently thin (<1 mm) as to allow for good heat transfer from the external surface to the thermoelectric cell. Examples of insulating materials that can be fabricated with sufficiently small thickness include steel (45 W/m·K), titanium (17 W/m·K), or even metal oxides, including but not limited to zirconia (ZrO₂, ˜2 W/m·K) and glass (SiO₂, 1.38 W/m·K).

In a preferred embodiment, the material of the top surface plate 106 is water stable. Water stability can be achieved in numerous ways including the application of thin surface coatings made from polymers, paints, spin coatings, deposits, and other methods to achieve thing coatings. Alternatively, the surface could be selected to be water stable based on its material properties. For example; aluminum, diamond, silicon carbide, are water stable. The material is preferably heat stable at temperatures up to at least 100° C. All material components including the thermoelectric components are preferably stable when exposed to boiling water.

The preferred embodiment includes a thermal cooling manifold 114 through the inclusion of a thermal block 116 with high surface area fins 118 that are either passively or actively cooled (e.g., using a small fan circulating cool air over them. The heat dissipation may also be enhanced with a passive or active closed loop liquid cooling system, or other heat management technology. Because thermoelectric cell performance increases with the difference in temperature between the hot side and the cold side of the device, the cooling manifold helps to improve performance by increasing the temperature difference. In other embodiments, additional thermoelectric devices are used to collect heat from the internal side of the thermoelectric cell, in a stacked format.

In a preferred embodiment, the scale will operate using thermal energy that is generated during the weighing of objects, and any excess energy is used to recharge the battery 124. The battery may be based on various technologies including Li-ion, Zn- and Ni-based, and other solid-state battery technologies. In addition, other energy storage technologies may be incorporated into the circuit, to either complement or entirely replace a battery. These include, capacitive devices, fuel cells, and any other electrochemical energy generating technology.

One of the challenges of using thermoelectric devices to harvest latent heat is that a single TEG cell 104 typically produces relatively low voltage and current. To address this issue, embodiments of the invention use multiple thermoelectric cells connected in a circuit topology (e.g., a mixture of series and parallel), so that both voltage and current are sufficiently high to charge the battery. This parallel/series circuit topology need not be static, but can be adaptively changed based on the available voltage and current.

Preferably, the array 102 of thermoelectric cells has a circuit topology that connects the cells in a mixture of parallel and series. In the event that the TEG array provides voltage that is too low, a step-up DC-DC converter may be used to increase the voltage to a required level for operating the device.

FIG. 1B illustrates several examples of cell sizes and circuit topologies, where similarly shaded squares are cells connected to each other in series and differently shaded squares are cells connected to each other in parallel. These circuit topologies can be adaptively configured by the microcontroller to maximize either voltage, current, or adjust the topology to meet other criteria, such as ensuring the voltage is at least a minimum threshold value but otherwise maximizing current. Arrangement 150 has a 3×3 grid of nine cells, where the differently connected cells form a checkerboard pattern where one group of five cells are connected in series with each other, another group of four cells are connected in series with each other, and these two groups are connected to each other in parallel. Arrangement 152 has a 6×7 grid of 42 cells, where the differently connected cells form a checkerboard pattern where one group of 21 cells in series is connected in parallel to another group of 21 cells in series. Arrangement 154 has a 6×7 grid of 42 cells, where the differently connected cells form alternating rows. Arrangement 156 has a 6×7 grid of 42 cells, where the differently connected cells form an arbitrary pattern, e.g., grouped dynamically based on the energy that each cell is producing. Arrangement 158 has a 6×7 grid of 42 cells, where there are six groups of cells connected to each other in parallel, each with seven cells in series. Arrangement 160 has a 6×7 grid of 42 cells, where there are three parallel-connected groups of cells forming concentric rectangular rings, each of the three groups having 6, 14, and 22 cells in series, respectively. This arrangement might be suitable for a situation where a hot object is placed in the center. The object will be hottest near the center and cooler near the circumference, so the arrangement of cells is selected so that more cells are allocated to the cooler circumference where each cell generates less power and fewer to the hot center where each cell generates more power. Other cell sizes and arrangements are also possible. For example, the array may include a mixture of large and small cells, or cells of different shapes, e.g., squares, rectangles, triangles, or hexagons.

In a preferred embodiment, the thermoelectric cell array 102 connects via a switching network 108 to an energy harvesting circuit in a power management circuit 126 that dynamically adjusts the connectivity of the cells using the switching network 108 to maximize the energy harvesting capability of the scale and balance the operation of the device with the charging of the battery. The system will dynamically adapt so that it will maximize power delivered to the battery depending on the battery state and battery type, the operating power consumption state, and the power being harvested from the array. The device can use maximum power point tracking (MPPT).

In some embodiments, the thermoelectric cells may be arranged in a stacked configuration, as shown in FIG. 2. This configuration allows for staged harvesting of temperature differentials. To do this effectively, the stacked thermoelectric cells preferably have different sizes. For example, a small thermoelectric cell 204 may be used on the hot side facing outwards and the cold side of that cell may directly contact the hot side of a slightly larger cell 202 sitting beneath it. Another even larger cell 200 is beneath cell 202. In such stacked embodiments the rate of thermal equilibration is relatively fast because the thermoelectric cells are good thermal conductors.

The microcontroller 120 preferably transitions from the use of thermoelectric power to stored electrical energy once the voltage and/or current from the thermoelectric array are sufficiently low that it will no longer directly power the device. The temperature differential for this transition will depend on the thermoelectric device material paired with the energy consumption requirements of the scale.

The power management circuit 126 dynamically maintains a consistent applied direct current (DC) voltage to the microcontroller 120 regardless of voltage fluctuations from the thermoelectric cell array. This voltage will be proportional and matched to that of the energy storage device, for example if a Li-ion battery is used, then 3.3 V will be the target voltage. DC-DC step up converters may be used in the power management circuit to help achieve the target operational voltage requirements. The use of a high quality, low loss transformer for the step-up converter is important to avoid heat dissipation can reduce the temperature differential and energy produced by the thermoelectric array.

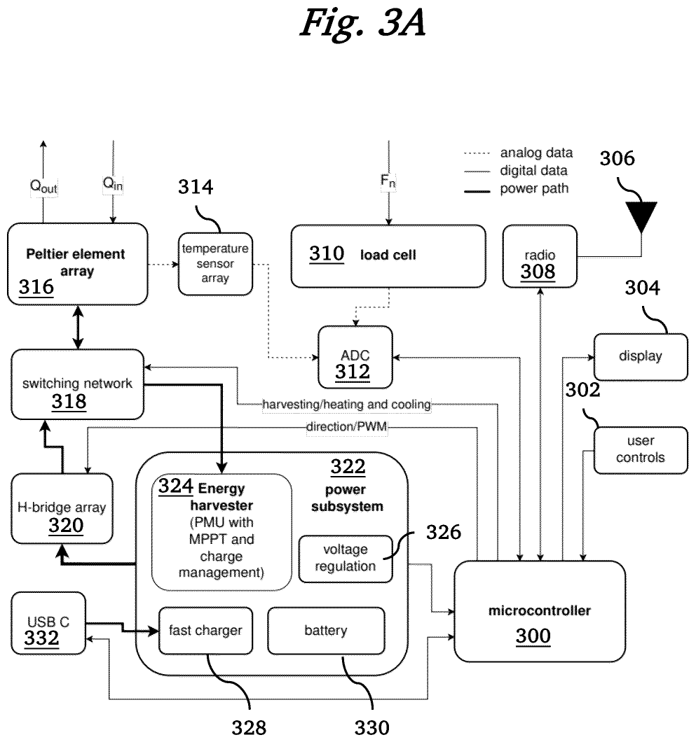

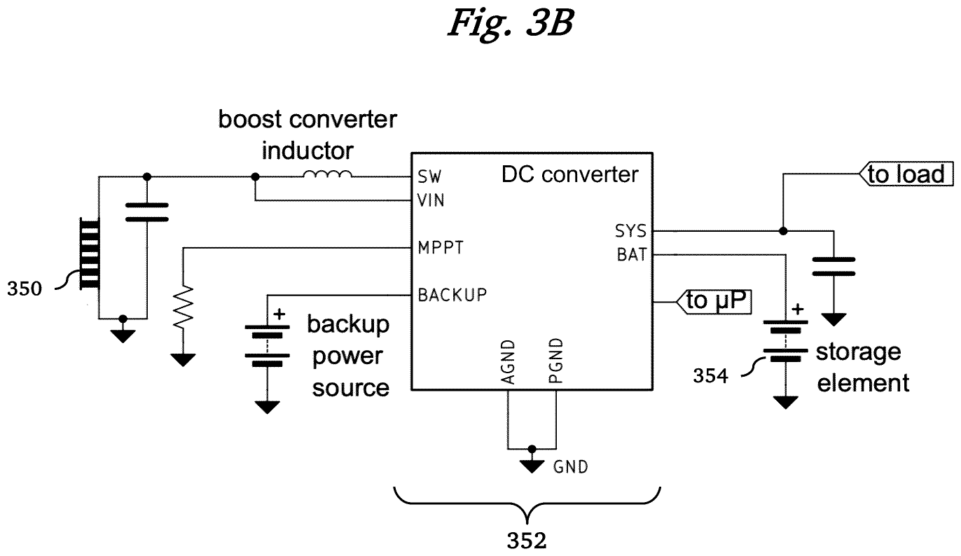

FIG. 3A shows a schematic block diagram of a thermoelectric scale according to another embodiment of the invention. In this embodiment, the scale is built around a low power microcontroller and supporting electronics 100 which controls all operations of the device based on user inputs 302. These operations include, but are not limited to, sensing the weight of an object placed on the scale as sensed by the load cell 310 via ADC 312, reading and displaying the energy harvested from the thermoelectric array 316, overseeing the energy power subsystem 322, selecting between various circuit topology configurations by controlling the switching network 318, sending scale output data to display 304 and to radio 308 which transmits using antenna 306, sensing TEG cell temperatures from a temperature sensor array 314 via ADC 312. Power from the TEG array 316 passes through the switching network 318 to the energy harvesting circuit 324 in the power subsystem 322. Power can also be provided from an external source via USB C power port 332. The energy power subsystem 322 also includes a fast charger 328 for managing the external power from USB C 332, a voltage regulator 326, and battery 330. Using an external power source, power may be delivered to the TEG array to operate it in reverse. This mode allows for active heating or cooling of the vessel on the scale surface. The direction of heat flow (i.e. either heating or cooling the surface) can be controlled by an H-bridge 320 or similar circuit. The H-bridge duty cycle may also be adjusted to deliver specific amounts of effective power to the TEG array, allowing for fine-grained temperature control.

FIG. 3B is a schematic that shows an example implementation of a TEG-based charging circuit according to an embodiment of the invention. A TEG 350 provides electrical power from a thermal gradient. DC converter 352 regulates, converts, and conditions the power for charging battery 354.

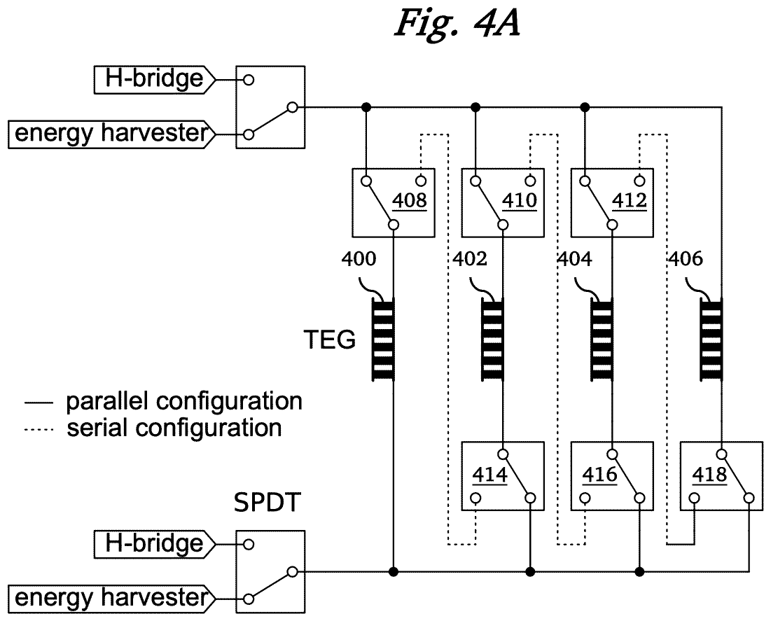

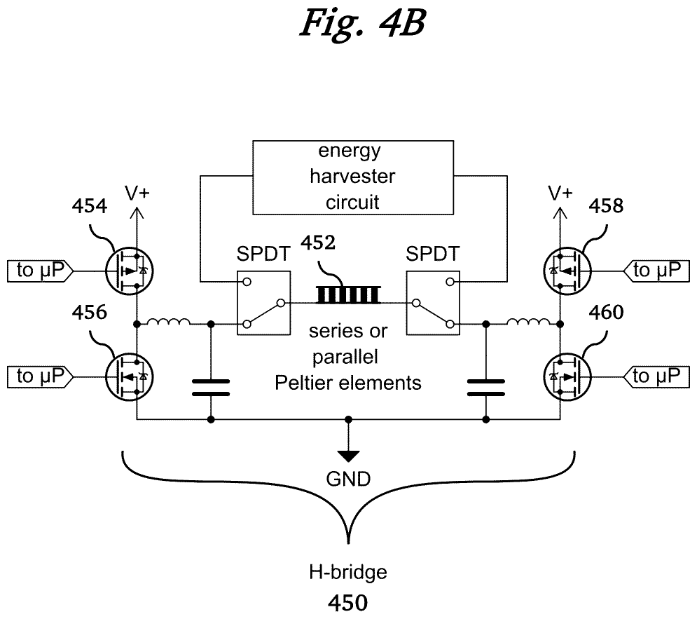

FIG. 4A is a schematic that shows an example implementation of four TEG cells 400, 402, 404, 406 in a parallel/series switchable array, according to an embodiment of the invention. The switches 408, 410, 412, 414, 416, 418 allow the TEG cells to be individually selected so that they are in parallel or in series with other TEG cells. Here, four thermoelectric cells are wired to be switchable between series and parallel, but the concept is generalizable ranging from all cells in parallel, to all cells in series, independent of number of cells. The switching circuit permits the adaptive connection of the four thermoelectric cells in various circuit topologies. The TEG can be any thermoelectric cell material, in any configuration (stacked or single, passive or active cooling, etc.). In all configurations the switching diagrams may be part of an integrated circuit or as a separate circuit.

The algorithms that may control circuits like that of FIG. 4A may measure output current and voltage of the on-board battery, and measure outgoing current and voltage produced by the TEG array, and adjust between series and parallel arrangements based on whether sufficient current and/or voltage is being provided to run the scale, charge the battery, or polarize the capacitors within. This may be programmed as hard cutoffs, e.g., circuits switching based on a voltage threshold, a current threshold, or a temperature difference threshold.

In another embodiment, a switch allows for the external power to be diverted to the TEG array, to run the thermoelectric cells in reverse, causing a heating of the internal surface of the TEG. This will also serve to charge the batteries faster (as the rate of wall charging depends on the battery temperature) and will also enable surface cooling on the outward facing surface of the scale, offering the possibility of allowing for cold-brewing applications while plugged into wall power.

Switching between heating and cooling modes is accomplished by reversing the direction of the current through the TEG array. This is accomplished using a polarity reversal circuit, such as an H-bridge 450 as shown in FIG. 4B. In this embodiment, the current direction through the TEG cells 452 is set by four power transistors 454, 456, 458, 460 controlled by the microcontroller. Using an H-bridge, the microcontroller can implement a pulse width modulation (PWM) or other modulation scheme to change the effective electrical power delivered to the TEG. By modulating the electrical power, active heating or cooling can be fine-tuned.

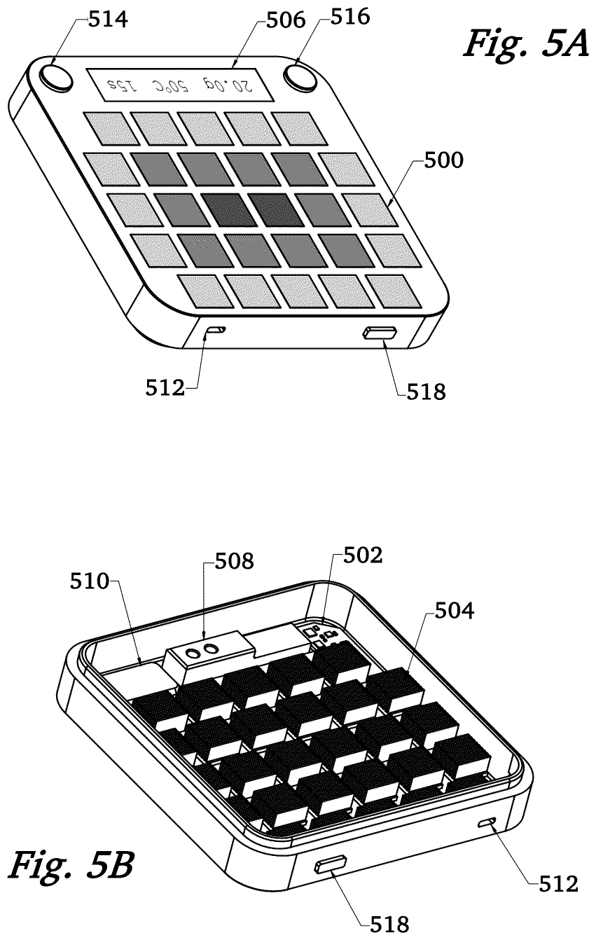

FIGS. 5A and 5B are perspective top and bottom views, respectively, of a thermoelectric scale according to an embodiment of the invention. In this implementation, a portable scale has a housing manufactured from aluminum. The thermoelectric cells 500 are passively cooled and the electrical components 502 are mounted to the underside of the upper portion of the scale. The cells are cooled by passive aluminum fins 504, with a thermocouple reporting the cold side temperature. A thermocouple will also be mounted on the hot side surface, and the difference in temperature will be reported on the scale's display 506. The scale will offer other display items, including the weight of the object on the scale, the change in weight over time, and also elapsed time (i.e., a stopwatch). The scale may be customized to weigh a coffee beverage as it is being brewed. This is a conventional application of a coffee scale using a load cell 508. As hot water percolates through a coffee bed and falls into a brewing vessel sitting on the scale, the vessel heats up, causing the hot side of the TEGs to create a potential difference. The longer the hot beverage is weighed, the longer the TEG will feature a potential difference and charge the battery 510 as well as power itself. This scale could then be used to weigh any hot or cold object of receptacle containing warm or cold liquids.

The scale will also function when weighing things that are not of markedly different temperatures to the cool interior of the scale. In that case, the device will draw on stored charge from the onboard battery 510. The scale will also be wall-chargeable through a USB C port 512, with or without passing current through the TEGs. The scale has user interfaces buttons 514, 516 and 518 which may be used for turning on/off the scale, to tare the scale, and for controlling other functions of the scale. For example, the buttons could be used to change the mode of the display to select the desired information to be displayed, or to manually select a different circuit topology for the TEG cells to accommodate a situation where a brewing vessel is not flat or centered on the scale surface.

In one embodiment, the scale should have a self-tarring feature where, when the TEG begins to generate charge, the scale tars itself. In one embodiment, the scale begins calculating and displaying a real-time flow rate when the scale detects a temperature difference (voltage) from the array.

In one embodiment, thermoelectric power can be temporarily buffered in a capacitor, which can be used to power an extreme low power Bluetooth transceiver, or the load cell, or the LED display, or a display backlight. The TEG power can be selectively routed to any one of these components if there is not sufficient power to operate them all. The microcontroller could select which component is powered, or the component could be manually selected.

For the hot plate/cold plate function, the cells can detect which cells are contacting the carafe based on the power each is generating. Therefore, the microcontroller can select which cells receive the power based on which cells are being contacted, thereby managing the internal temperature and not wasting energy heating or cooling the surface that isn't actually touching the carafe.

1. A thermoelectric powered digital scale comprising:
a weighing platform comprising an array of thermoelectric generator cells and a surface plate attached to a top side of the array, wherein the array is adapted to produce electrical energy from a temperature gradient across opposite sides of the array;
a switching network electrically connected to the array;
a load cell mechanically coupled to the weighing platform;
a thermal cooling element thermally coupled to a bottom side of the array and comprising a thermal block and a collection of fins adapted to dissipate heat;
a digital display;
a rechargeable battery;
a microcontroller circuit electrically connected to the switching network and the digital display;
wherein the microcontroller is adapted to determine a weight from signals received from the load cell and send signals indicating the weight to the digital display;
wherein the microcontroller is adapted to control the switching network to adaptively change between multiple electrical circuit topologies of the thermoelectric generator cells;
a power management circuit electrically connected to the switching network, the rechargeable battery, and the microcontroller, wherein the power management circuit comprises an energy harvesting circuit and a voltage regulation circuit;
wherein the energy harvesting circuit is adapted to harvest electrical energy from the array of thermoelectric generator cells;
wherein the power management circuit is adapted to provide operating power to the microcontroller and the display;
wherein the power management circuit is adapted use available power from the energy harvesting circuit for the operating power and for recharging the rechargeable battery.

2. The thermoelectric powered digital scale of claim 1, wherein the power management circuit is adapted use power from the rechargeable battery for the operating power when the electrical energy generated by the thermoelectric cell array is insufficient to provide operating power to the microcontroller and the display.

3. The thermoelectric powered digital scale of claim 1, further comprising a thermal switch adapted to divert energy to the rechargeable battery when the electrical energy from the array drops below a predetermined threshold power.

4. The thermoelectric powered digital scale of claim 1, wherein the power management circuit is adapted to maximize power delivered to the rechargeable battery depending on power consumption and a charge state of the rechargeable battery.

5. The thermoelectric powered digital scale of claim 1, wherein the power management circuit is adapted to perform maximum power point tracking (MPPT).

6. The thermoelectric powered digital scale of claim 1, further comprising an external power port electrically connected to the power management circuit, wherein the power management circuit is adapted to receive external electrical power to charge the rechargeable battery and/or to operate the thermoelectric cells in reverse to function as a hot plate or a cold plate.

7. The thermoelectric powered digital scale of claim 1, wherein the microcontroller is adapted to control the switching network to adaptively select individual cells in the array based on which cells are generating power.

8. The thermoelectric powered digital scale of claim 1, wherein the microcontroller is adapted to control the switching network to adaptively select between a series topology, a parallel topology, and a mixture of series and parallel circuit topologies of the thermoelectric generator cells.

9. The thermoelectric powered digital scale of claim 1, further comprising temperature sensors thermally coupled to the top side of the array and to the bottom side of the array, wherein the microcontroller circuit is electrically connected to the temperature sensors and is adapted to determine a temperature differential.

10. The thermoelectric powered digital scale of claim 1, wherein the array of thermoelectric generator cells comprises vertically stacked thermoelectric generator cells having various different sizes.

11. The thermoelectric powered digital scale of claim 1, wherein the thermoelectric generator cells comprise a material with a thermoelectric figure of merit, zT, that exceeds 0.2.

12. The thermoelectric powered digital scale of claim 1, wherein the thermoelectric generator cells have a thickness of at least 2 mm.

13. The thermoelectric powered digital scale of claim 1, wherein the surface plate comprises a material with a thermal conductivity exceeding 100 W/m·K.

14. The thermoelectric powered digital scale of claim 1, wherein the surface plate comprises a material film with a thickness less than 1 mm.

15. The thermoelectric powered digital scale of claim 1, wherein the microcontroller is adapted to compute a dynamic estimate of a change in weight per unit time.

16. The thermoelectric powered digital scale of claim 1, wherein the microcontroller is adapted to automatically tar the scale when the electrical energy from the array changes from zero to a positive value.
